(19) United States
(12) Patent Application Publication
(10) Pub. No.: US 2016/0183510 A1
(43) Pub. Date: Jun. 30, 2016

(54) FISHING LINE RETRIEVAL SYSTEM AND METHOD

(71) Applicant: Nigel Paul CONYBEARE, Tring, Hertfordshire (GB)

(72) Inventor: Nigel Paul Conybeare, Tring (GB)

(21) Appl. No.: 14/910,776

(22) PCT Filed: Jul. 29, 2014
(86) PCT No.: PCT/GB2014/052316

§ 371 Date: Feb. 8, 2016

(30) Foreign Application Priority Data
Aug. 9, 2013 (GB) 1314315.1

(51) Int. Cl. A01K 97/24

(52) U.S. Cl. CPC A01K 97/24

(57) ABSTRACT

A fishing line retrieval system has a body (1) having a central aperture (4), a capture device (5) to capture fishing line (10) running through the central aperture and a retrieval line (8) connected to the body (1). In use, the body is slipped over a trapped fishing line (10), so that the fishing line runs through the central aperture (4) and the body is allowed to sink through body of water in which the fishing line is trapped. The retrieval line (8) is used to manipulate the body so that the capture device (5) captures the fishing line and then pulled on to release the caught fishing line.

This invention relates to the safe retrieval system for the removal of fishing line and equipment from impedance or obstruction.

This invention relates to the safe retrieval of fishing line and equipment from impedance or obstruction, wherein if fishing with either a pole or rod and one gets ones fixing equipment caught up on a obstruction either above or below water there are currently only two ways that this obstruction can be cleared. You may wish to pull hard on the rod or pole, both of which have inherent dangers of either the obstruction clearing and the compound force of the rod or pole will accelerate the terminal tackle back to the operator resulting in potential facial damage or loss of an eye. Alternatively so much force is applied that the rod or pole snaps inflicting financial damage without clearing the obstruction. The last option that can be used is that the line may be cut. This will not clear the obstruction but will mean that the fishing appendage (e.g. rod or poll) can be used again without damage to the fisherman, but it could and will have environment issues for the fishery as long lengths of line can be discarded and be floating within the water line ensnaring wild life and fish.

To overcome these problems the present invention proposes the use of a retrieval systems the system consist of a body, split ring swivel and hand controller, and is either slid over a fishing pole as it is totally smooth or is clipped on the line in the case of a fishing rod where rings are used to guide the line. The system works by utilises uni- and bi-directional force at the point of impediment that will release the line at or very close to the obstruction. Minimal force is applied through the fishing appendage relieving the stress on the rod/pole minimising the risk for both “flyback” of the terminal tackle or the potential that the appendage may fracture and break. The method of retrieval is such that if the line does break it will break at the point of obstruction so that no discarded tackle can be left within the area.

The retrieval system is a block of alloy that has been geometrically shaped so that is passes either over a fishing pole body or is snapped on to the line. Then by lowering the retrieval system to the river, lake or sea bed, the line from the fishing appendage has to be deflected such that it lays flat from the fixed point (at the obstruction) to the retrieval system and then to the fishing appendage. With careful lifting of the fishing appendage the retrieval system will slid down to the obstruction. Whilst the retrieval system is sliding down to the obstruction line from the retrieval system will be paid out from the hand line handle. Once the retrieval system reaches the obstruction gentle pulling force is applied to the line that holds the retrieval system. The line from the fishing appendage to the obstruction will then self feed into the off set logarithmic spiral situated at the opposite end to the force of pull ensnaring the line so that it can not come out of the spiral. At this point force can be applied via both the fishing appendage and the retrieval system line such that the line between the fishing appendage and the obstruction can have both horizontal and vertical forces applied. Vertical via the fishing appendage and horizontal via the hand line attached to the retrieval system. To assist in the removal of the terminal tackle from the obstacle additional change of direction can be applied via the hand line. Removal of the terminal tackle will occur without risk to life or limb and is environmentally friendly as there will not be any equipment left in the water.

According to a first aspect of the present invention there is provided a fishing line retrieval system, comprising:
a body having a central aperture;
a capture device to capture fishing line running through the central aperture; and
a retrieval line connected to the body.

The capture device may comprise a slot in the body. The capture device may comprise a non return slot in the body, such as a spiral slot. In one embodiment, the slot has the shape of a logarithmic spiral.

In one embodiment, the capture device is positioned on the opposite side of the body to the retrieval line. This has the advantage that pulling on the retrieval line will channel fishing line in the central aperture into the capture device.

The body may have a substantially elliptical shape. The central aperture may be substantially circular. The inner surface of the central aperture may be smooth.

The body may comprise a through-slot extending from the outside of the body to the central aperture, to allow fishing line to be fed into the central aperture. The through slot may be off-set from an axis between the retrieval line and the capture device. The through-slot may comprise a non return slot. The through-slot may comprise may be kinked to prevent return of the fishing line. For example, the kink may comprise a change of direction of the through-slot.

The body may be sufficiently heavy to sink in sea water. The body may be sufficiently heavy to sit on a river, lake or sea bed. The body may be metallic, for example it may be fabricated from an alloy.

The fishing line retrieval system may further comprising a connector which connects the retrieval line to the body. The body may comprise a hole for connection to the connector. The connector may comprise a ring, for example a split ring.

The retrieval line may comprise a hand line. The retrieval line may comprise a hand controller and/or a line winder. The retrieval line may be connected to the opposite side of the body to the capture device.

A second aspect of the invention relates to a method of retrieving fishing line using a fishing line retrieval system outlined above, the method comprising:
(a) placing the body on a fishing line which is trapped, such that the fishing line runs through the central aperture;
(b) allowing the body to slide down the fishing line which is trapped;
(c) using the retrieval line to manipulate the body so that the capture device captures the fishing line; and
(d) pulling on the retrieval line to release the trapped fishing line.

A third aspect of the invention relates to a method of releasing a fishing which is trapped on an obstruction in a body of water, the method comprising:
passing a body having an aperture over the trapped fishing line;
allowing the body slide down the fishing line to the obstruction;
using a retrieval line to manipulate the position of the body so that a capture device captures the fishing line running through the central aperture; and
pulling on the retrieval line to release the fishing line.

The fishing line may be inserted into the central aperture by pulling it through a through-slot extending from the outside of the body to the central aperture. Alternatively, where the fishing line is connected to a fishing pole, step (a) may comprise passing the body over the fishing pole until the fishing line runs through into the central aperture.

The retrieval line may be pulled in a direction substantially transverse to the direction of the fishing line.

Throughout the description and claims of this specification, the words “comprise” and “contain” and variations of the words, for example “comprising” and “comprises”, mean “including but not limited to”, and do not exclude other components or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, characteristics or steps described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

The present invention will now be further described with reference to the following non-limiting examples and the accompanying illustrative drawings, of which:

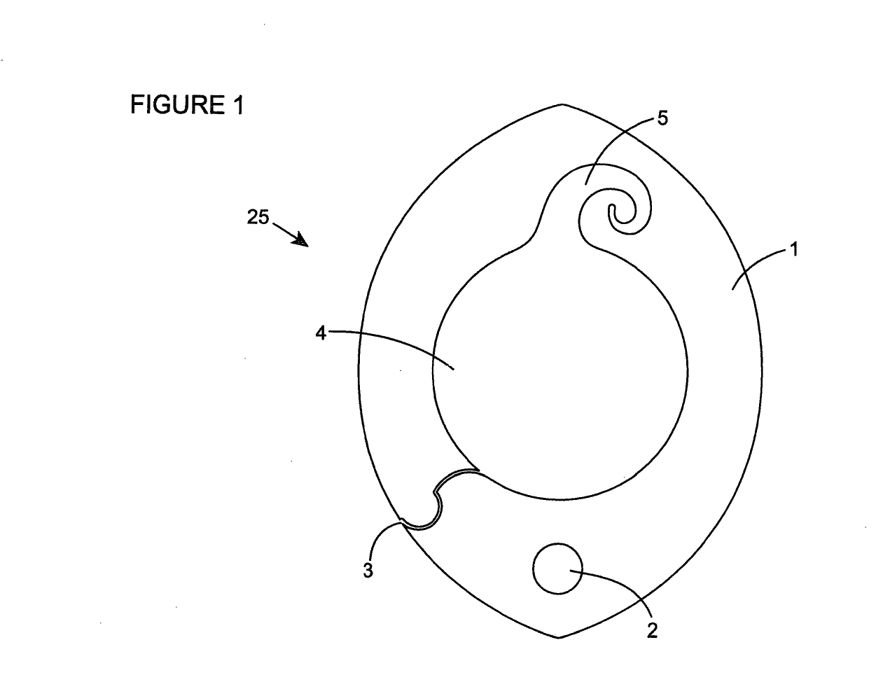

FIG. 1: Shows the plan view of the body of the retrieval system;

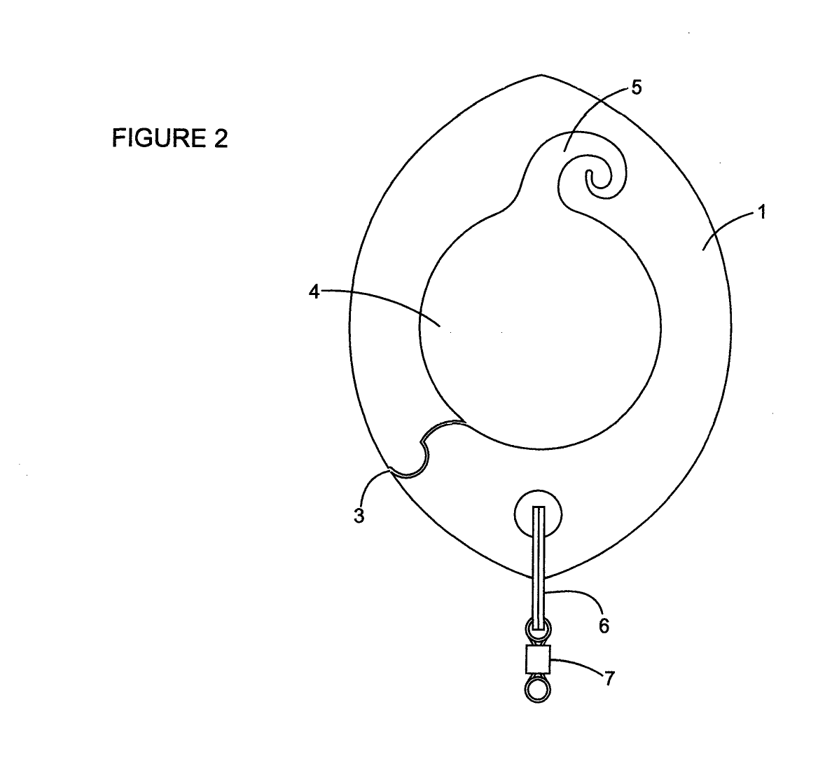

FIG. 2: Shows the plan view of the body of the retrieval system with the additional of the swivel and split ring;

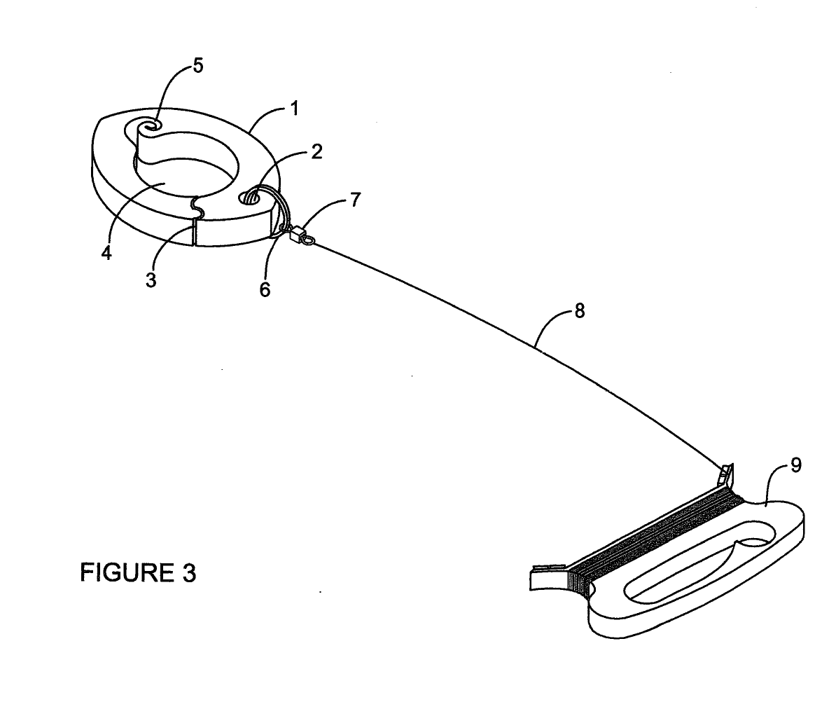

FIG. 3: Shows the total retrieval system;

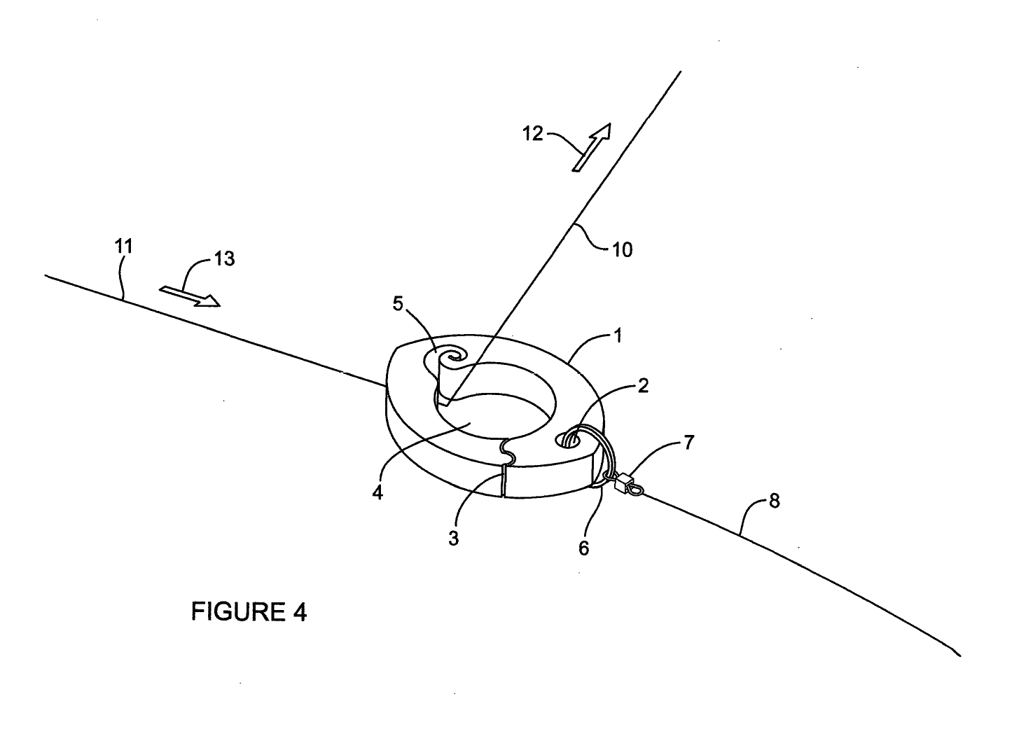

FIG. 4: Shows the start of the engagement of the retrieval system interacting with the line;

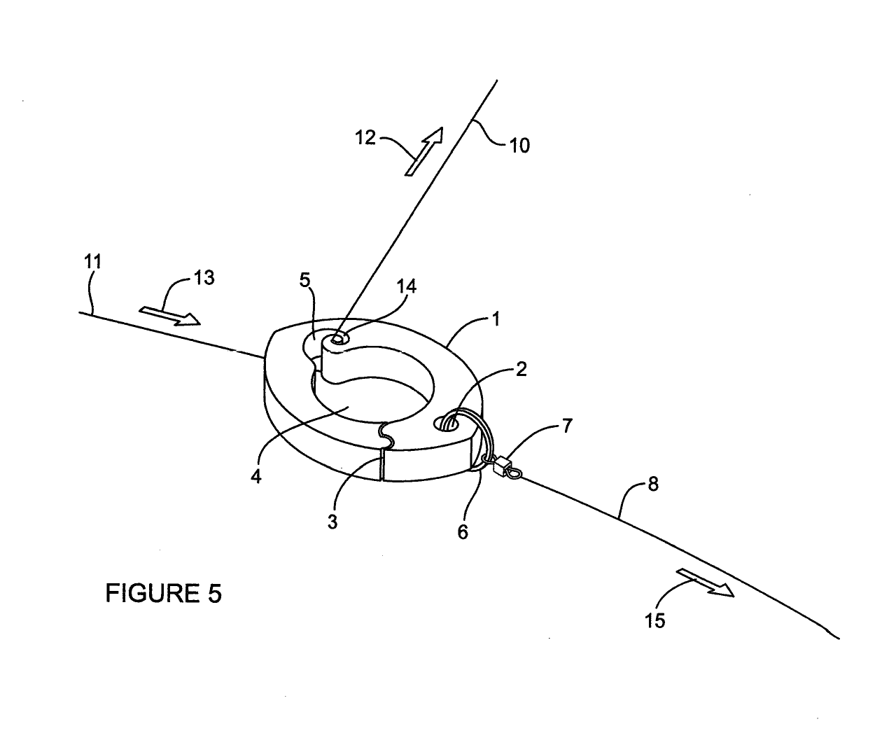

FIG. 5: Shows the line full engaged with the logarithmic spiral;

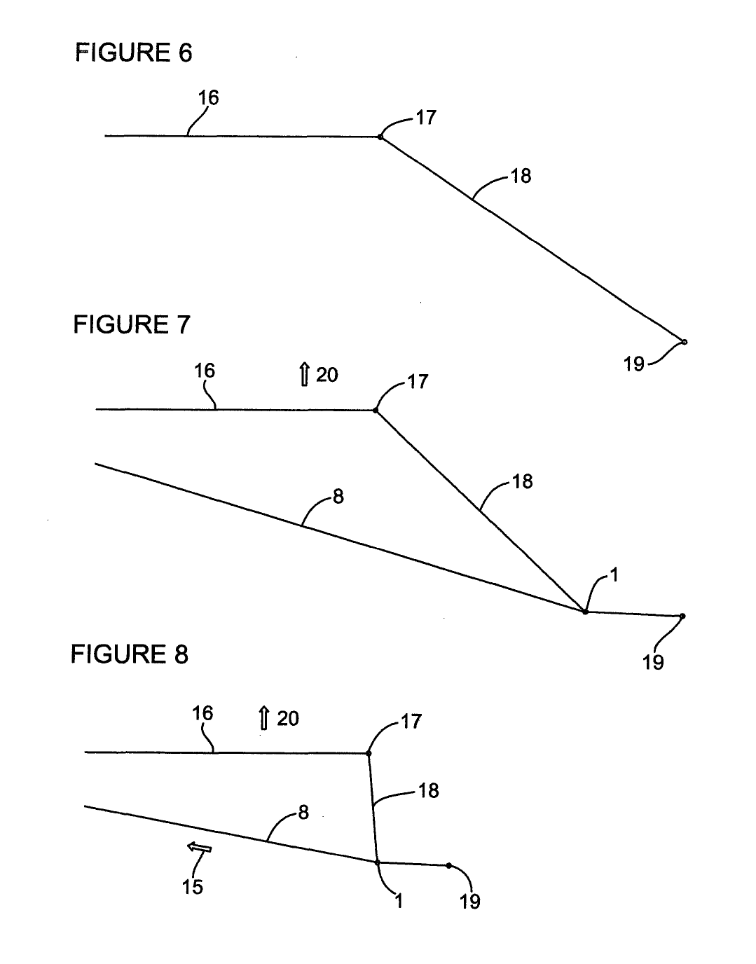

FIG. 6: Shows a schematic diagram of the issues where fishing appendage, line and obstruction are viewed;

FIG. 7: shows the schematic diagram of FIG. 6 but with the insertion of the retrieval system;

FIG. 8: shows the same schematic diagram as FIGS. 6 and 7 with the retrieval system in use;

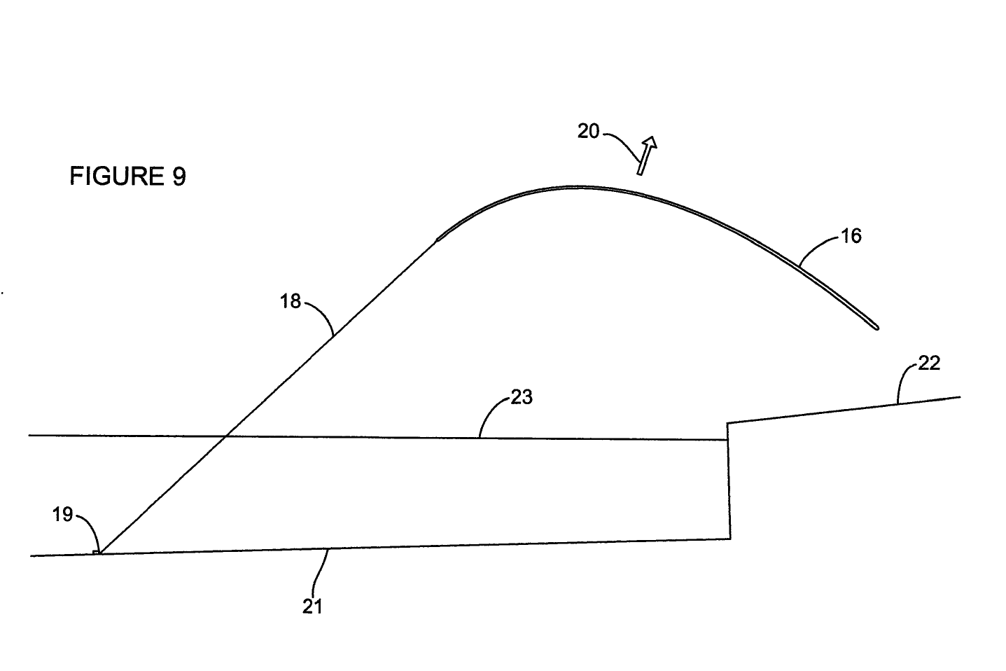

FIG. 9: shows the side view of the fishing appendage, line and obstruction;

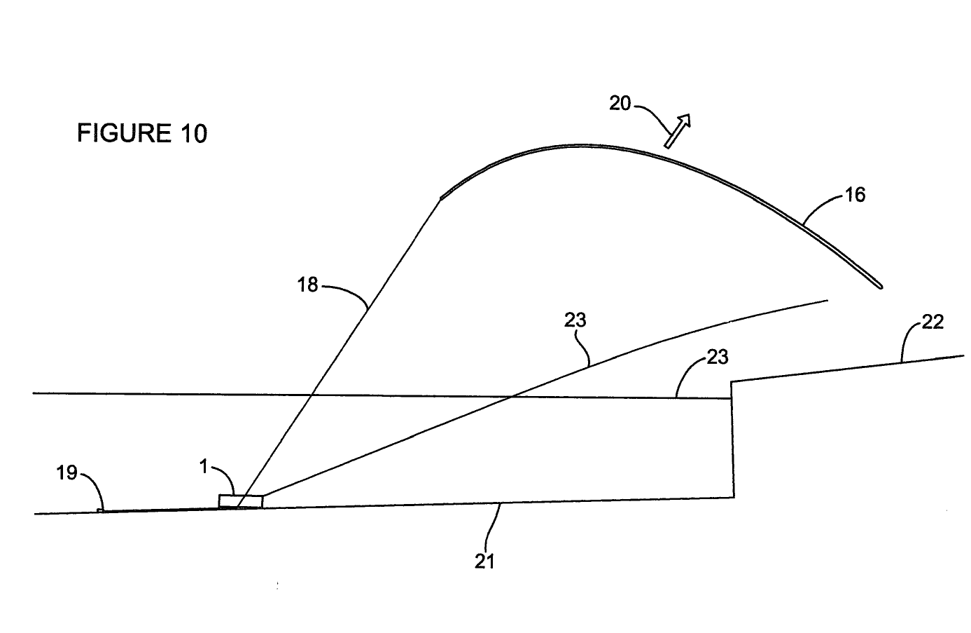

FIG. 10: shows the side view but with the insertion of the retrieval system;

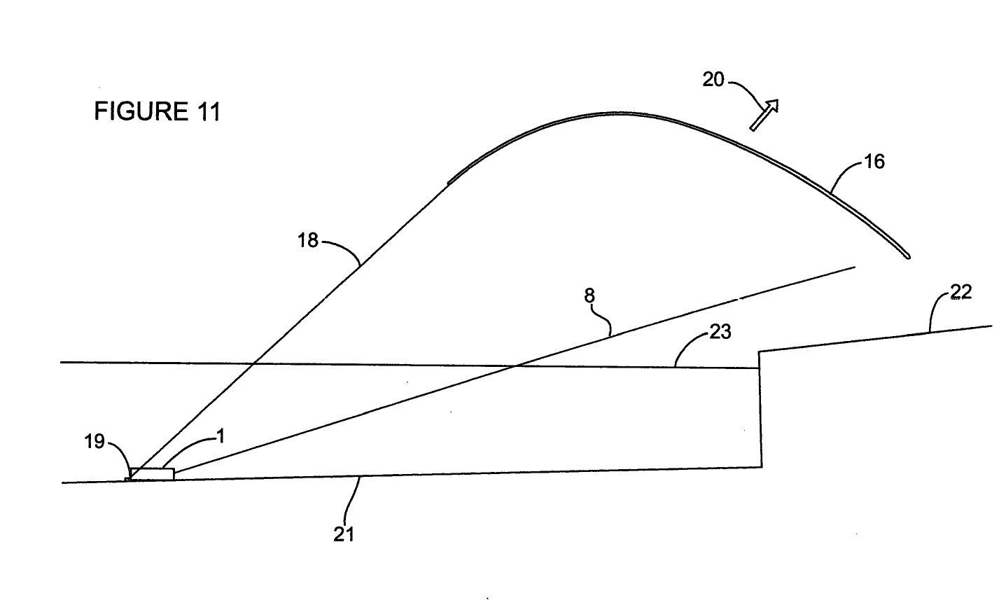

FIG. 11: shows the side with the retrieval system in use; and

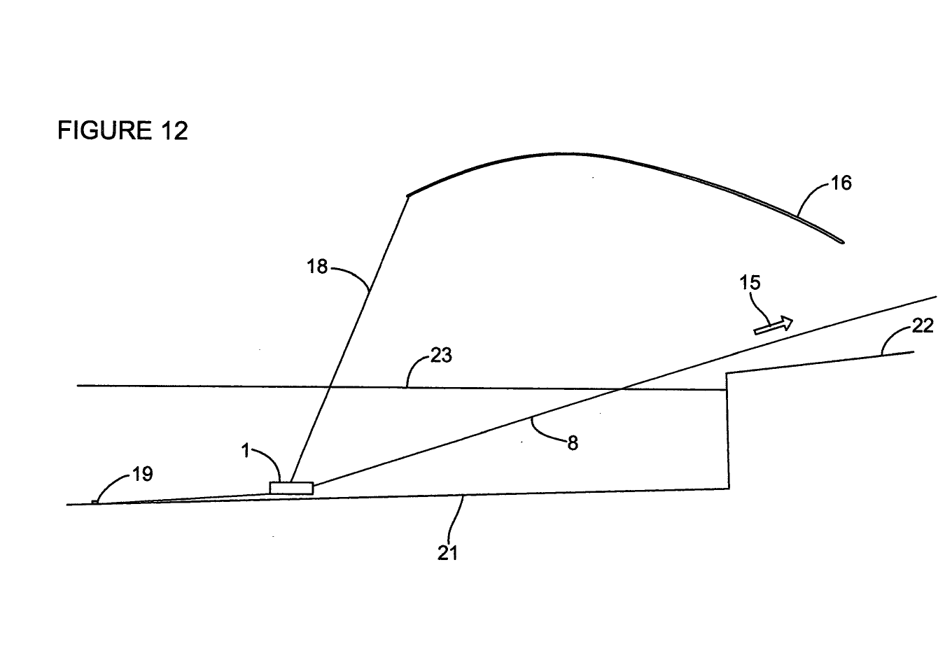

FIG. 12: shows the how the system works.

In FIG. 1, the body 1 of the retrievable unit 25 is elliptical and has sufficient self weight to be allowed to slide down both the pole and the line whilst also being held static to the bed of the river, lake, sea bed. The unit 25 includes a preset hole 2 which is about the centre line of the ellipse to accept a split ring 6, it also includes a non return offset slot 3 that will allow the line to be fed into the body of the retrievable unit. This slot is so designed as to confuse and complicate the non return of the line back out from the body of the system. The body also has a central aperture 4 within its construction which is multi purpose; the diameter of the central aperture facilitates the sliding on of the body over the pole. The other use of the central aperture 4 is to allow the line to run free without entrapment so that it can be manipulated close to the obstruction. The body 1 also has an offset logarithmical spiral 5 which is position with its opening about the centre line of the body.

In FIG. 2 the body component 1, now includes a split ring 6 and a swivel 7. These two components allow for total lateral flexibility of the system that will be required when the body is in motion both sliding down the pole and the line until it hits the bed and becomes static. By applying tension on 7 & 6 the orientation of the system can be fixed.

In FIG. 3 the retrieval system is now complete with the addition of the connecting hand line 8 and the hand controller and line winder 9.

In FIG. 4 we see the retrieval system engaged, the body of the system 1 is hard on the bed of the river, sea or lake. The line 10 from the rod or pole runs within the central aperture 4 where the body 1 of the retrieval unit 25 has been either slid over the pole using the central aperture 4 or the line 10 has been fed in to the body 1 using the non return offset slot 3. At this point the line 10 runs from the obstruction 11 flat on the river bed changing the angle between the obstruction and the rod/pole. The line from the hand control 9 to the body of the retriever is slack.

In FIG. 5 the retrieval system has been manipulated closer to the obstruction by simply lifting the rod or pole. Once the retrieval systems can no longer mover closer to the impediment the system can be activated. Gentle pulling force 15 can be applied to the hand line 8. This will enable the system body to move away from the obstruction at the same time self locating the line 10 within the offset logarithmical spiral 5 that entraps the line. At this time uni and bi directional forces can be applied at the point of obstruction. An upwards force 12 applied by the fishing rod or pole, a lateral pulling force 15 applied by the hand line attached to the retrieval unit 25 and change of direction of pull due to the flexibility of the swivel 7 and split ring assembly 6; these forces will either disentangle the obstruction or snap the line close to the point of obstruction, with minimum compression exerted on the rod or pole so that the rod/pole will not be under risk of breaking.

In FIGS. 6, 7 & 8 are schematic diagrams illustrating the operation of the system. FIG. 6 shows the fishing appendage (i.e. rod/pole) 16, the fixed point of the line exiting the fishing appendage 17, the line 18 and the fixed point of obstruction of the line 19.

In FIG. 7 we see that the body 1 of the retrieval unit 25 has been engaged via either the body 1 being slid over the pole with no line rings or by clipping the body 1 onto the line. The line 18 now clearly shows the change of direction from an overhead perspective between the fixed point 17 of the line exiting from the fishing appendage 17 and the fixed point of the obstruction 19. The body 1 of the retrieval unit 25 is manipulated closer to the fixed point 19 of the obstruction by lifting the rod/pole 16 in direction 20 (shown in FIG. 8).

FIG. 8 shows the pressure exerted on the body 1 by lifting the pole/rod 16 in direction 20 and by pulling via the hand line 8 attached to the body 1 that will facilitate the release of the line 18 from the fixed point of the obstruction 19.

FIGS. 9-12 show side views of a fishing pole and line being released from an obstruction according to the present invention.

In FIG. 9 shows a body of water 23 and its bed 21 and bank 22. The fishing pole 16 and line 18 are shown, with the line 18 trapped at 19 by an obstruction. Conventionally a fisherman would pull in direction 20 to release the fishing line.

FIG. 10 shows the body 1 of the retriever unit 25 installed and sitting on the bed 21 of the river, lake, sea bed.

In FIG. 11 we see that the body 1 of the retrieval unit 25 has been manipulated close to the fixed or snagged point 19 caused by the obstruction.

In FIG. 12 we see that the retrieval system is being activated with force being applied to the body 1 via pressure to hand line 8, this will then facilitated the safe release of the line 18 from the obstruction at fixed point 19.

1. A fishing line retrieval system, comprising:
a body having a central aperture;
a capture device, comprising a non return slot in the body, to capture fishing line running through the central aperture; and
a retrieval line connected to the body.

2. A fishing line retrieval system according to claim 1, wherein the capture device comprises a spiral slot in the body.

3. A fishing line retrieval system according to any one of the preceding claims, wherein the non return slot of the capture device has the shape of a logarithmic spiral.

4. A fishing line retrieval system according to any one of the preceding claims, wherein the body has a longitudinal axis and wherein the capture device is located substantially on the longitudinal axis.

5. A fishing line retrieval system according to any one of the preceding claims, wherein the body has a substantially elliptical shape.

6. A fishing line retrieval system according to any one of the preceding claims, wherein the central aperture is substantially circular.

7. A fishing line retrieval system according to any one of the preceding claims, wherein the inner surface of the central aperture is smooth.

8. A fishing line retrieval system according to any one of the preceding claims, wherein the body comprises a through-slot extending from the outside of the body to the central aperture, to allow fishing line to be fed into the central aperture.

9. A fishing line retrieval system according to claim 8, wherein the body has a longitudinal axis and the through-slot is offset from said longitudinal axis.

10. A fishing line retrieval system according to any one of claim 8 or 9, wherein the through-slot comprises a non return slot.

11. A fishing line retrieval system according to any one of claims 8 to 10, wherein the through-slot is kinked to prevent return of the fishing line.

12. A fishing line retrieval system according to any one of the preceding claims, wherein the body is sufficiently heavy to sink in sea water.

13. A fishing line retrieval system according to any one of the preceding claims, wherein the body is sufficiently heavy to sit on a river, lake or sea bed.

14. A fishing line retrieval system according to any one of the preceding claims, wherein the body is metallic.

15. A fishing line retrieval system according to any one of the preceding claims, wherein the body is fabricated from an alloy.

16. A fishing line retrieval system, further comprising a connector which connects the retrieval line to the body.

17. A fishing line retrieval system according to claim 16, wherein the body comprises a hole for connection to the connector.

18. A fishing line retrieval system according to any one of claim 16 or 17, wherein the connector comprises a ring, such as a split ring.

19. A fishing line retrieval system according to any one of the preceding claim, wherein the retrieval line comprises a hand line.

20. A fishing line retrieval system according to any one of the preceding claims, wherein the retrieval line comprises a hand controller.

21. A fishing line retrieval system according to any one of the preceding claims, wherein the retrieval line comprises a line winder.

22. A retrieval system according to any one of the preceding claims, wherein the body has a longitudinal axis and wherein the retrieval line is connected substantially in line with said longitudinal axis.

23. A method of retrieving fishing line using a fishing line retrieval system according to any one of claims 1 to 22, the method comprising:
(a) placing the body on a fishing line which is trapped, such that the fishing line runs through the central aperture;
(b) allowing the body to slide down the fishing line which is trapped;
(c) using the retrieval line to manipulate the body so that the non return slot of the capture device captures the fishing line; and
(d) pulling on the retrieval line to release the trapped fishing line.

24. A method according to claim 23, wherein the non return slot of the capture device comprises a spiral slot and wherein step (c) comprises using the retrieval line to manipulate the body so that the fishing line is captured by the spiral slot.

25. A method according to any one of claim 23 or 24, wherein the non return slot of the capture device has the shape of a logarithmic spiral and wherein step (c) comprises using the retrieval line to manipulate the body so that the fishing line is captured by the logarithmic spiral slot.

26. A method of releasing a fishing which is caught on an obstruction, the method comprising:
passing a body having aperture over the caught fishing line;
allowing the body slide down the fishing line which is trapped;
using a retrieval line to manipulate the position of the body so that a capture device comprising a non return slot captures the fishing line running through the central aperture; and
pulling on the retrieval line to release the trapped fishing line.

27. A method according to claim 26, wherein the non return slot of the capture device comprises a spiral slot and wherein the retrieval line is manipulated to position the body so that the fishing line is captured by the spiral slot.

28. A method according to any one of claim 27, wherein the non return slot of the capture device has the shape of a logarithmic spiral and wherein the retrieval line is manipulated to position the body so that the fishing line is captured by the spiral slot.

29. A method according to any one of claims 23 to 28, wherein the fishing line is inserted into the central aperture by pulling it through a through-slot extending from the outside of the body to the central aperture.

30. A method according to any one of claims 23 to 29, wherein the fishing line is connected to a fishing pole and step (a) comprises passing the body over the fishing pole until the fishing line is inserted into the central aperture.

31. A method according to any one of claims 23 to 30, wherein the retrieval line is pulled in a direction substantially transverse to the direction of the fishing line.

32. A fishing line retrieval system substantially as herein described with reference to the accompanying illustrative drawings.

33. A method of retrieving fishing line substantially as herein described with reference to the accompanying illustrative drawings.
